(19) United States
(12) Patent Application Publication
(10) Pub. No.: US 2004/0266370 A1
(43) Pub. Date: Dec. 30, 2004

(54) Independent application module

(75) Inventor: Einar Ulrichsen, Kristiansand (NO)

Correspondence Address: VOLPE AND KOENIG, P.C., UNITED PLAZA, SUITE 1600, 30 SOUTH 17TH STREET, PHILADELPHIA, PA, 19103, US

(73) Assignee: CellJump Ltd., Luton Bedfordshire (GB)

(21) Appl. No.: 10/817,699

(22) Filed: Apr. 2, 2004

(30) Foreign Application Priority Data
Apr. 2, 2003 (NO) 2003 1051

(51) Int. Cl. H04B 1/04

(52) U.S. Cl. 455/123

(57) ABSTRACT

The invention relates to a device wherein a handheld battery-powered unit communicates with an external handheld peripheral unit by direct electrical contact, wherein said battery-powered unit at least comprises a processor and a storage medium or media, and also has a communication port for peripheral units, characterised in that said handheld peripheral unit comprises at least one or more battery cells and a data chip, wherein the data chip of the said peripheral unit at least comprises a storage medium in which there is stored software that can be exchanged with the battery-powered handheld unit.

### FIELD OF THE INVENTION

The invention describes a device and a method, wherein a handheld battery-powered unit communicates with an external handheld peripheral unit without the use of a cable, electromagnetic waves or beams such as radio waves, ultrasonic waves or infrared light, and wherein said battery-powered unit at least comprises a processor and a storage medium or media, and also has a communication port for peripheral units. The present invention relates in particular to a handheld battery-powered unit which communicates with a replaceable battery pack comprising storage media and warning media.

### BACKGROUND OF THE INVENTION

Portable handheld units such as mobile telephones, smartphones, PDAs (Personal Digital Assistants) and the like are by their very nature dependent upon an adequate power supply in order to function satisfactorily. If the handheld unit's internal battery is discharged, the unit will cease to function. Often, the user will not have a battery charger with him, and so the handheld unit loses its function. If the user has a charger with him, he may not always have access to the mains.

Handheld units will often be sophisticated devices where advanced internal electronics are controlled by software. The said advanced internal electronics are often able to perform tasks of a far more advanced nature than is the case at the time the said device is introduced to the market. It is conceivable that new software applications may provide extra functionality for the said handheld unit.

Today, it is common practice to release sophisticated handheld units onto the market before they are equipped with mature software, and therefore ostensibly identical devices on the market will often appear to be different as they are controlled by different software.

To overcome the aforementioned problems, there are known devices and methods. U.S. Pat. No. 6,323,621B1 describes a device for charging portable computers. Said device comprises a solution wherein an electrical lead has a first connection for connecting the lead to an external first power source, e.g., the mains, a second connection for electrically connecting the lead to an external battery, and lastly a third connection for electrically connecting the lead to the said portable computer, wherein the first connection is electrically connected to the second connection and the third connection allows simultaneous electrical coupling to the external battery and the portable computer.

This solution is cumbersome and will not be suitable for smaller portable handheld units where precisely a compact exterior is essential. The said solution is also cumbersome because it uses cable connections between the external battery and the electrical load.

From the mobile market there is known a simple device in the form of battery packs which can be coupled directly to mobile telephones. The said battery packs are of the disposable type, and can be coupled to the power input jack of a mobile telephone. The battery pack will be capable of recharging the internal battery of the mobile telephone to some extent. As soon as the battery pack is connected to the power input jack of the mobile telephone, the telephone's jacks for peripheral units will also be physically blocked, as the said battery pack will cover these jacks. Furthermore, there is no way of monitoring or controlling the battery capacity of the said battery pack.

To overcome the problem of old software in handheld portable units, there are several methods for downloading updated software. It is known, for example, that from a mobile telephone it is possible to download software via WAP (Wireless Application Protocol). There are also solutions allowing users to download software via the Internet. The said solutions have a number of limitations and deficiencies. When downloading via WAP, the user is initially dependent upon being able to establish a reliable WAP connection. Problems may arise when downloading software if the WAP connection is broken. Furthermore, not all mobile telephones are prepared for WAP. The said solution also requires the user to be familiar with the WAP pages and to know how to use WAP.

The solution where software is downloaded from the Internet requires the handheld unit to have access to the Internet, either directly or via an external computer. Today, there are a limited number of handheld units that are prepared for direct connection to the Internet. For those that have this facility, the same problems will apply as those that apply in the case of downloading via WAP. Alternatively, the handheld unit may be connected to a computer, where said computer can download applications from the Internet. This connection may be made by cable, infrared connection or via BlueTooth®. This solution is also rather unsuitable for downloading software. If a connection between the handheld unit and the computer via a cable is desirable, such a cable must be available. Furthermore, specially adapted software in the said computer is also needed to enable the handheld unit and the computer to communicate.

The solutions for BlueTooth® or infrared communication between the handheld unit and the computer require both the computer and the handheld unit to have these solutions implemented therein. Furthermore, it will also often be necessary for the computer to have specially adapted software for communication with the handheld unit. Another obvious drawback is that the user must have access to a computer which has Internet access.

Another variant for updating software for handheld units would be to take the product to a dealer who has specially adapted equipment for updating software. This solution involves the owner of the handheld unit finding a dealer. It also requires that the dealer should always have the most recent update of the software. Often, the owner of the handheld unit will also have to hand over his device for a longish period of time to allow the software update to take place. Another drawback of the last solution is that it is not flexible as regards several software suppliers being able to easily supply software to this dealer.

### SUMMARY OF THE INVENTION

To remedy these and a number of other obvious weaknesses exhibited by the aforementioned solutions, the present invention teaches a method and a device as defined in the attached independent claims.

Specifically, reference is made to an external handheld peripheral unit characterised in that said peripheral handheld unit comprises at least one or more battery cells and a data chip, wherein the said peripheral unit data chip at least comprises a storage medium in which is stored software that can be exchanged with the battery-powered handheld unit.

### BRIEF DESCRIPTION OF THE FIGURES

To facilitate understanding of the invention, the following description will refer to the attached figures.

FIG. 1 shows an embodiment of the invention in which the handheld battery-powered unit is a mobile telephone.

### DETAILED DESCRIPTION OF A PREFERRED EMBODIMENT OF THE INVENTION

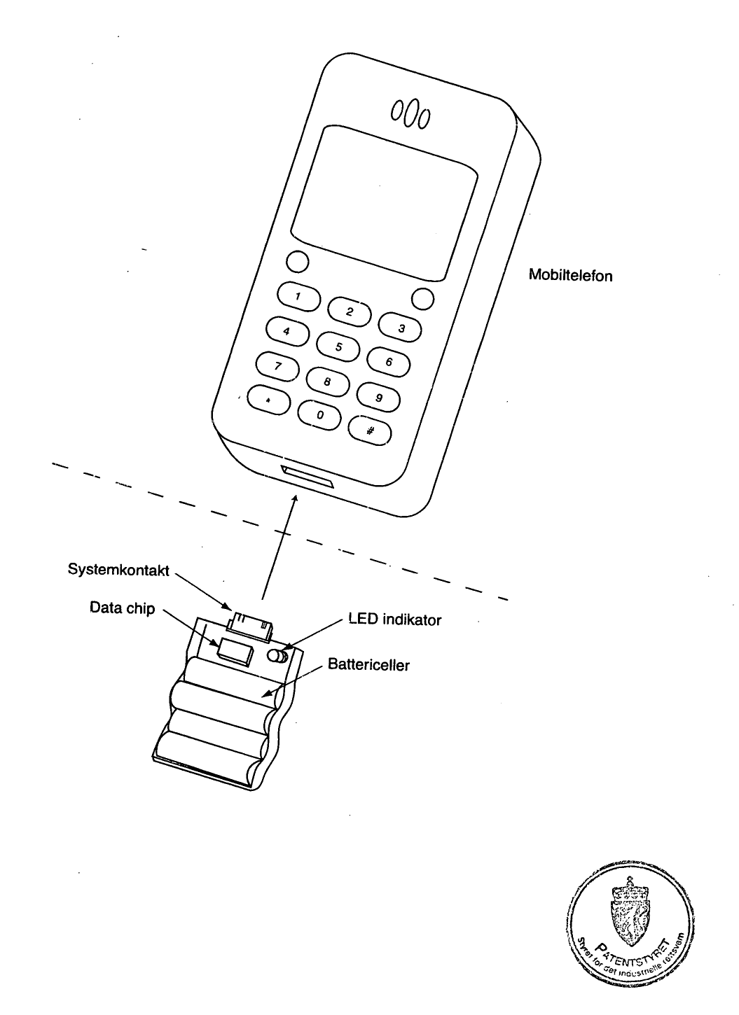

In the following description the present invention will be described by means of an example. FIG. 1 shows a possible embodiment of the invention. The individual inventive features of the invention will be described with reference to FIG. 1. A mobile telephone, or any other handheld battery-powered unit comprising an internal memory and at least one processor, will be able to make use of the invention. In what follows, the invention will be described in connection with a mobile telephone in order to simplify the description. At one end thereof, most available mobile telephones have a power supply jack and a jack for peripheral units such as serial cables for connection to a computer, a hands-free kit, a radio, an MP3 player, a camera and the like. The different manufacturers of mobile telephones have not agreed upon a standardised jack for power supply or peripheral units, and the peripheral unit shown in the figure will have to be adapted to the interface of the individual manufacturers. In principle, the idea will nevertheless be applicable to all commercially available mobile telephones that are chargeable and incorporate a microprocessor and a memory, and which are capable of upgrading their internal software. Thus, it is not a task of this invention to solve problems associated with the physical design of the connection between the external battery and the mobile telephone.

The external peripheral unit comprises a part designed for battery cells. These battery cells are intended to be used for high-speed charging of the mobile telephone's internal rechargeable battery. The capacity of these battery cells will depend upon the chosen technology, whilst the chosen technology will be a question of price. If Lithium Manganese Dioxide (LiMnO₂) batteries are chosen, the capacity could be high, for cylindrical cells with spiral electrodes, typically 160 mAh-1.4 Ah at a nominal charge of 3.2 V. If cheaper and simpler battery cells are used such as alkaline batteries, the capacity will be reduced by as much as 50% as their Wh capacity per cm³ is much lower. Furthermore, in those cases where alkaline batteries are used, it will be necessary to connect in series three cells to be able to supply sufficient voltage, as an alkaline battery cell will normally supply 1.1-1.3 V at a moderate load. The said conditions apply to all peripheral units having the same cubic measurements.

If desirable, it will of course be possible to use advanced rechargeable batteries in the external peripheral unit, such as Li-Ion batteries. However, with a solution of this kind much of the point of the invention would disappear as the user would thus be dependent upon a charger, and the possibility of using the peripheral unit as an “emergency battery” would be poorer than for non-rechargeable batteries.

One of the weaknesses of today's “emergency batteries” for mobile telephones is that there is no way of checking the remaining capacity of the battery pack. In the present invention an activation button is installed between the battery cells and the system connector. This serial connector is simply activated when the external peripheral unit is used for the first time. Advantageously, this connector will be so designed that a first-time activation will be visible. This can be accomplished by having a form of seal which is broken in order to activate the connector. One of the points of this is to ensure that the external peripheral unit cannot be misused without this being visible.

Once the connector has been activated, the peripheral unit, when connected to a mobile telephone, will via the peripheral connectors thereof cause the light-emitting diode shown in FIG. 1 to emit light when there is sufficient charging current to provide the mobile telephone with voice functionality. If the battery capacity of the external peripheral unit is too low to enable a connected mobile telephone to obtain voice functionality, the aforementioned light emitting diode will emit light having a warning colour which indicates low remaining capacity.

The invention is also provided with a data chip, which data chip at least comprises a memory, and it may also comprise a guard circuit against overcharging of the connected mobile telephone following the same methods as some of the battery chargers for mobile telephones use. Said memory will at least contain a software application for communication with the mobile telephone. The said software application will preferably be AT commands, which are used for data transfer from the external peripheral unit to the mobile telephone.

The data chip could contain software updates adapted to the connected mobile telephone so that the internal software thereof is updated. The software application stored in the data chip will not be limited to updates of existing software in the mobile telephone. Other useful programs, limited solely by the internal memory of the mobile telephone, such as games, ringing tones, pictures and the like, could conceivably be transferred. The software applications that are to be transferred to the mobile telephone will be written in a language adapted to a particular model. However, the actual communication protocol will be based on AT commands. Once the mobile telephone has downloaded the application found in the external peripheral unit, the data chip of the said peripheral unit will render further downloading of applications impossible. In this way, problems associated with the copyright of the stored applications of the peripheral unit will be prevented.

Once the software has been downloaded on the mobile telephone, the peripheral unit will merely function as an external “emergency battery”, the residual capacity of which can be seen from the aforementioned warning lamp. In the cases where back-up batteries will be needed for storing data on the said data chip in the peripheral unit, the battery cells shown in the figure will meet this need.

In the above the invention is limited to a peripheral unit for a mobile telephone for downloading software combined with an “emergency battery” and an associated warning lamp. However, the invention will not be limited to only comprising peripheral units for mobile telephones, as all handheld battery-powered devices with an integrated memory and a processor, and a connector for communication with a peripheral unit, such as, but not limited to, PDAs, smartphones, portable computers, handheld GPS (Global Positioning System) receivers and advanced remote controls, will be comprised by the invention,

What is claimed is:

1. A device wherein a handheld battery-powered unit communicates with an external handheld peripheral unit by direct electrical contact, wherein said battery-powered unit at least comprises a processor and a storage medium or media, and also has a communication port for peripheral units, wherein said handheld periperhal unit comprises at least one or more battery cells and a data chip, wherein the data chip of the said peripheral unit at least comprises a storage medium in which there is stored software that can be exchanged with the battery-powered handheld unit.

2. A device according to claim 1, wherein said peripheral unit comprises a system connector that is suitable for being snapped on to the handheld battery-powered unit.

3. A device according to claim 1, wherein said software is communicated between the handheld battery-powered unit and the peripheral unit using AT commands.

4. A device according to claim 3, wherein said software comprises applications to enhance the functionality of the handheld battery-powered unit.

5. A device according to claim 1, wherein said handheld peripheral unit may be a Personal Digital Assistant (PDA), a smartphone, a portable computer, a handheld Global Positioning System (GPS) receiver or an advanced remote control.

6. A device according to claim 1, wherein the said peripheral unit has a battery overcharge protector incorporated therein.

7. A device according to claim 1, wherein the battery cells of the said peripheral unit may be of the disposable type or rechargeable, or if not rechargeable, one of the following types: lithium manganese dioxide, alkaline manganese dioxide, zinc-air battery, silver oxide or mercury battery.

8. A device according to claim 1, wherein the handheld periperhal unit includes a warning lamp.

9. A device according to claim 8, wherein said warning lamp is a lamp showing the remaining capacity of the external battery cells, in that said lamp can assume different colours depending on the remaining capacity of the battery cells.

10. A device according to claim 9, wherein said warning lamp is a semiconductor lamp, preferably of the light-emitting diode type.

11. A device according to claim 1, wherein the handheld peripheral unit includes a switch.

12. A device according to claim 11, wherein said switch is an activation switch which shows whether said handheld peripheral unit has been activated, and said switch must be activated in order for the peripheral unit to function.
